(19) United States
(12) Patent Application Publication
(10) Pub. No.: US 2016/0381108 A1
(43) Pub. Date: Dec. 29, 2016

(54) Co-device to a Mobile Device for Integrated Use and Experience of Mobile Applications on Another Device and Display

(71) Applicants: Bart Van Coppenolle, Lubbeek (BE); Johan Cloetens, Kessel-Lo (BE)

(72) Inventors: Bart Van Coppenolle, Lubbeek (BE); Johan Cloetens, Kessel-Lo (BE)

(21) Appl. No.: 15/193,067

(22) Filed: Jun. 26, 2016

Related U.S. Application Data
(60) Provisional application No. 62/185,408, filed on Jun. 26, 2015.

(51) Int. Cl. H04L 29/06; H04W 4/06

(52) U.S. Cl. CPC H04L 65/60; H04W 4/06; H04L 65/4076; H04N 21/4126

(57) ABSTRACT

Systems and methods are provided for employing a co-device with a mobile/second device for sharing a user experience of mobile applications on both the mobile/second device and another display/first device.

### FIELD OF THE INVENTION

The technology of this disclosure relates generally to a shared user experience between a first device and a second device via a third device, and more specifically but not exclusively to employing a co-device with a mobile device for sharing a user experience of mobile applications on both the first and second devices.

### BACKGROUND OF THE INVENTION

Various first or second screen companion applications (“apps”) exist for users who want to combine user experiences (“UX”) between first screen devices (e.g. Television (“TV”) or some other larger screen device) and second screen devices (e.g. mobile device—such as but not limited to a smart phone, tablet computer, laptop computer, e-reader, smart watch, gaming console, etc.). These apps provide the ability for social interaction, search, synchronization, obtaining additional information or content, dealing with broadcast content on TV screens etc. However conventional first and second screen companion apps provide a fragmented experience and multitasking stress as a result of the UX on the second screen not being integrated with the UX on the first screen.

Conventional casting and mirroring devices such as Roku, Google Chromecast and Apple TV with AirPlay can stream video through a platform specific app from the Cloud to a TV or mirror video or general images from games or mobile applications running on a mobile device to a TV for easier viewing. However, these conventional systems feature a limited UX, which can only partially be improved by adding an extra remote control (e.g. Roku or Apple TV). But this added remote control also detracts from the user experience, by requiring yet another device for the user to operate the system.

These conventional streaming devices require platform specific apps to operate. Thus the content available for each platform is limited to a small subset of all of the available mobile apps, even though most mobile apps are ubiquitously available—just not compatible with these devices.

It would thus be advantageous to create systems and methods that integrate the app use and display on the mobile (second) device with the simultaneous use and display of the same app by the same user on another device which is interfaced to or integrated with the larger screen (first) device, as such integrating big and small screen UX, in a classical mosaic user interface (UI) or new right brain interface (as disclosed in U.S. Pat. No. 8,489,527 entitled “Method and Apparatus for Neuropsychological Modeling of Human Experience and Purchasing Behavior”, U.S. Pat. No. 8,495,683 entitled “Method and Apparatus for Content Presentation in a Tandem User Interface”, U.S. patent application Ser. No. 13/941,651 entitled “Method and Apparatus for Neuropsychological Modeling of Human Experience and Purchasing Behavior”, U.S. patent application Ser. No. 13/947,276 entitled “Method and Apparatus for Content Presentation in a Tandem User Interface” and U.S. patent application Ser. No. 14/575,042 entitled “Video Presentation Interface with enhanced navigation features” the disclosures of which are incorporated herein as if fully set forth.

### BRIEF SUMMARY OF THE INVENTION

Many advantages will be determined and are attained by the technology of the present disclosure, which in a broad sense provides systems and methods for employing a co-device with a mobile device for sharing a mobile application user experience on both the first and second devices.

One or more configurations of the technology provide(s) a system for integrating a use and experience of a shared mobile application over a mobile device and a display device. The system includes a processor based device, at least one mobile application being stored on the processor based device, a mobile device in selective communication with the processor based device and a display device in selective communication with the processor based device. The mobile device is configured to remotely access and control at least a portion of the mobile application which is stored on the processor based device. The processor based device is configured to display the mobile application on the display device.

One or more configurations of the technology provide(s) a method of integrating a use and experience of a mobile application over a mobile device and a display device. The method includes the mobile device selectively communicating with a co-device. The co-device includes the mobile application stored on the co-device. The mobile device remotely operates at least a portion of the mobile application and the co-device displays the remotely controlled mobile application on a display device which is in selective communication with the co-device.

The technology will next be described in connection with certain illustrated embodiments and practices. However, it will be clear to those skilled in the art that various modifications, additions and subtractions can be made without departing from the spirit or scope of the claims.

### BRIEF DESCRIPTION OF THE DRAWINGS

For a better understanding of the technology, reference is made to the following description, taken in conjunction with the accompanying drawings, in which like reference characters refer to like parts throughout, and in which:

FIG. 1 illustrates a block diagram of a system in accordance with one or more aspects of the described technology;

FIG. 2 illustrates a flow diagram in accordance with one or more aspects of the described technology;

The technology will next be described in connection with certain illustrated embodiments and practices. However, it will be clear to those skilled in the art that various modifications, additions, and subtractions can be made without departing from the spirit or scope of the claims.

### DETAILED DESCRIPTION OF THE INVENTION

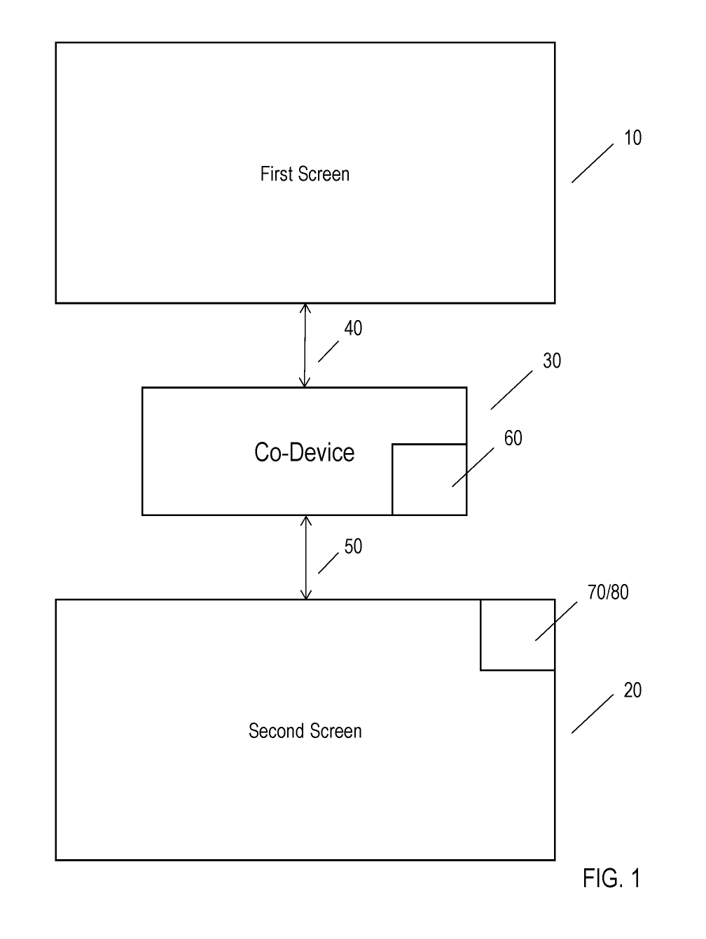

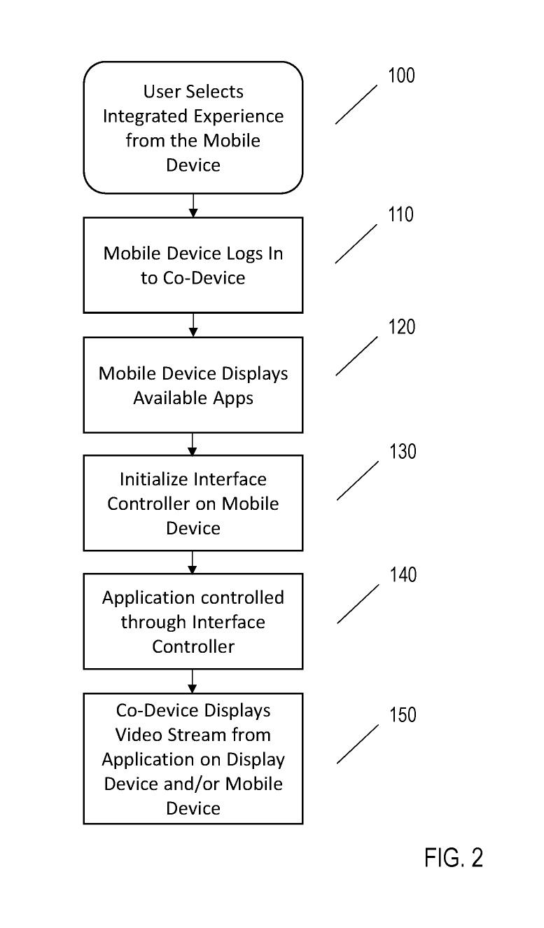

Referring to the drawings in detail wherein like reference numerals identify like elements throughout the various figures, there is illustrated in FIGS. 1-2 an integrated user experience solution, sharing apps and users over different integrated or interfaced devices. While only a very limited number of system elements (e.g. First device 10, second device 20, co-device 30, connections 40/50) are illustrated, those skilled in the art will recognize this is only done for simplicity purposes and that the invention is not so limited. Multiple first 10 and/or second 20 screens could be simultaneously connected to the co-device without departing from a spirit or scope of one or more claims. Additionally, there could be multiple co-devices for sharing mobile app user experiences on first 10 and second 20 devices.

The following description is provided as an enabling teaching as it is best, currently known. To this end, those skilled in the relevant art will recognize and appreciate that many changes can be made to the various aspects described herein, while still obtaining the beneficial results of the technology disclosed. It will also be apparent that some of the desired benefits can be obtained by selecting some of the features while not utilizing others. Accordingly, those with ordinary skill in the art will recognize that many modifications and adaptations are possible, and may even be desirable in certain circumstances, and are a part of the technology described. Thus, the following description is provided as illustrative of the principles of the technology and not in limitation thereof. Discussion of an embodiment, one or more embodiments, an aspect, one or more aspects, a feature or one or more features is intended be inclusive of both the singular and the plural depending upon which provides the broadest scope without running afoul of the existing art and any such statement is in no way intended to be any more limiting in nature. Technology described in relation to one of these terms is not necessarily limited to use in that particular embodiment, aspect or feature and may be employed with other embodiments, aspects and/or features where appropriate. Additionally, technology described in relationship to an embodiment, aspect or one or more embodiments/aspects does not necessarily require nor does it necessarily preclude that technology from being included in every possible aspect or embodiment of the invention.

Many advantages of the technology will be determined and are attained by the technology which, in a broad sense, provides systems and methods for integrating user experiences by sharing user experiences on a mobile device 20 with another device 30, interfaced or integrated with another screen. In one or more embodiments, a mobile device hardware alias/co-device 30 which can be a streaming stick or a set-top-box (“STB”) or a dongle, or some other processor based device running a conventional operating system (e.g. Android), is provided for using and viewing mobile/second device 20 applications on another/first device 10 (e.g. a TV with a larger display) in an integrated user experience with the second/mobile device 20. The mobile device 20 controls the mobile app 60 running on the hardware alias device 30 through a companion app 70 running on the mobile device 20 emulating the mobile app 60 running on the hardware alias device 30 as if it were running on that mobile device 20.

The app 60 may be a conventional Android app, and the co-device 30 may be an Android high-definition multimedia interface HDMI stick (pluggable into the HDMI port of the first device 10) which includes code which allows the co-device to behave as if it were the mobile device 20 (emulate the mobile device) by taking on the identity of that mobile device 20 (as its physical extension becoming effectively its co-device), downloads the necessary app(s) and no longer runs the app(s) on the mobile device 20, but instead runs the app 60 on the co-device 30. Those skilled in the art will recognize that the technology is not limited to Android based apps or to HDMI sticks. The app 60 is run on the co-device 30 and the video stream or images is/are mirrored from the co-device 30 to the mobile device 20. On the mobile device 20 a companion app 70 runs, instead of the original app. The companion app 70 receives input from the mobile device 20 and transmits the input to the co-device 30 as emulated touch commands. The co-device 30 which in a preferred but not required embodiment employs the first device 10 as the main display for the app 60, while casting back (sending images back or streaming video back) to the mobile device 20.

In terms of system architecture, the mobile device 20 can be any conventional mobile device 20 such as a phone, tablet, computer, e-reader, portable computer, or any other device capable of running user apps. The co-device 30 is a processor based device that runs on a conventional operating system and which may include one or more of wireless (e.g. Bluetooth, Infra-Red (“IR”), WiFi, satellite, etc.) and wired connections. The co-device 30 also preferably, but not required to be, is capable of connecting to the Internet and/or some other network via a conventional connection. The co-device 30 may be connected via a two-way communication path 50 with the mobile device 20. This communication path 50 may be wireless, wired or some combination thereof. The co-device 30 also includes a two-way communication path 40 with the device 10, which for purposes of the following description will be limited to a TV, but which is not in actuality so limited.

In one or more embodiments the communication path 40 between the co-device 30 and the TV 10 may be a single direction path from the co-device 30 to the TV 10, although a duplex path is preferred. The communication path 40 between the co-device 30 and the TV 10 may also be wireless, wired, some combination thereof or the co-device 30 may be configured to plug into the TV 10 (e.g. into a USB port, Ethernet port or an HDMI port or some other port located on the TV 10). This is essentially the same as or equivalent to a wired connection with very short wires.

In operation, as illustrated in FIG. 2, a user selects the integrated experience 100. In a preferred embodiment, the mobile device 20 registers with/synchs with/logs in to/is authorized by 110 the co-device 30 (collectively referred to as login and these terms may be used interchangeably herein such that the circumstances of use provide the broadest scope without making the meaning ambiguous or encompassed by prior technology). While not preferred or recommended, it is considered within a scope of one or more claims that this login may be bypassed or eliminated. In one or more embodiments, the first screen device 10 also logs in to the co-device 30, although as with the mobile device 20 this step, while preferred, may be bypassed without departing from the spirit or scope of one or more of the claims. The remaining description assumes a configuration which requires both logins, but those skilled in the art will recognize that the description is readily adaptable to a configuration with one or no login requirements.

Once the mobile device 20 is logged-in to the co-device 30, the mobile device 20 displays 120 the available apps that are present on the mobile device 20. Preferably, but not required, the apps 60 on the co-device are the same as those on the mobile device 20. If an app from the mobile device 20 is not available on the co-device 30, the user may be provided with an option to synch the devices in which case either the co-device 30 downloads the requested or all missing apps from the Internet and/or it downloads them from the mobile device 20.

The synchronization takes into account the type of mobile device 20 and the type of co-device 30 (to correctly download and play the equivalent app for the co-device 30 but play it to the first device 10 and back cast it/mirror it to the display of the mobile device 20. The resolutions for the first and second devices will be taken into consideration as well as for the app. The login, ensures that the user of the co-device 30 is the same user as the user of the mobile device 20 (this may be accomplished by confirming the user account credentials on both devices and encrypting the various communications).

Alternatively, the user may be provided with a selection of apps 60 available on the co-device 30. When a user selects an available app 60 available on the co-device 30, the mobile device 20 initializes 130 an interface controller 80 (which may be the companion app 70 located on the Mobile device 20) which allows messages to be sent from companion app 70 to the app 60 on the co-device 30 until the user stops interacting with the app. The companion app 70, which is employed for all apps while in the integrated experience, runs on the mobile device 20 and send messages to the co-device 30 that emulate touch commands on the co-device 30 as if the co-device 30 were a mobile device 20 with a touch screen 140. This companion app is different from the app itself and is general for all apps. The app 60 is being run entirely, or in part on the co-device 30, with the co-device 30 providing correctly formatted display information 150 to the TV 10. Additionally, the co-device 30 is providing correctly formatted display information 150 back to the mobile device 20. For the TV 10 the format may be the HDMI standard or some other standard depending on the co-device 30 and the television 10, and for the mobile device the format may be fixed to work on all mobile devices, may be based on the format defined by the companion app and/or may be determined by querying the mobile device for its display and resolution. In this way, the user of the mobile device 20 can look at either the display on the mobile device 20 or the display on the TV 10. In one or more embodiments, the user may be provided with an option to have one display at a time and/or may be provided with an option to toggle between displays.

When a user inputs information into the mobile device (e.g. via keyboard, mouse, ball, touch screen, etc.) that information is translated into potentially different ‘as if’ commands on the co-device 30, enabling the co-device 30 to represent the input on the TV 10 (e.g. the visual feedback of a cursor or other screen object indicating where the as if touch on the touch screen of the mobile would occur on the TV). The communication received from the companion app on the mobile device is translated by software running on the co-device 30 towards native key or touch input commands to the underlying operating system layer, as if such operating system layer would have received such commands from a regular keyboard or touchscreen. Thus, the mobile device 20 acts as a remote control for the co-device 30. The input at the mobile device 20 controls the input to the app 60 running on the co-device 30 and displayed on the TV 10 and/or mobile device 20.

While particular embodiments have been disclosed, those skilled in the art will recognize that the invention is not so limited. For example, a single mobile device 20 could connect with and operate multiple co-devices 30 simultaneously. Multiple mobile devices 20 may simultaneously connect with the same co-device 30. Additionally, or alternatively, a single co-device 30 could be connected to multiple first devices 10. Such a configuration could be helpful for meetings, presentations, gaming, etc. By way of a non-limiting example, a mobile device 20 could be employed with one or more co-devices 30 which in turn is/are connected to multiple other mobile devices 20 and a main display 10 (e.g. a TV). The multiple other mobile devices 20 would only act as display devices 10 and would not provide control over the co-device operations. Thus, rather than having to try to see the person operating the mobile device 20 or the main display 10 that the person is using for the presentation (assuming that there is a “main” display) participants/spectators to the presentation or game could instead simply connect their mobile devices 20 to the co-device 30 and watch the presentation or play the game on their mobile device 20. This could also be useful in a college lecture or virtual gaming environment.

Having thus described preferred embodiments of the technology, advantages can be appreciated. Variations from the described embodiments exist without departing from a scope of the claims. For example, while the above disclosure only references use and display, the technology may also be employed with or for audio as well. Thus it is seen that integrated mobile and other screen app use and experience solutions are provided. Although particular embodiments have been disclosed herein in detail, this has been done for purposes of illustration only, and is not intended to be limiting with respect to the scope of the claims, which follow. In particular, it is contemplated by the inventors that various substitutions, alterations, and modifications may be made without departing from a spirit and scope of the technology as defined by the claims. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

Insofar as embodiments of the technology described above are implemented, at least in part, using a computer system, it will be appreciated that a computer program for implementing at least part of the described methods and/or the described systems is envisaged as an aspect of the technology. The computer system may be any suitable apparatus, system or device, electronic, optical, or a combination thereof. For example, the computer system may be a programmable data processing apparatus, a computer, a Digital Signal Processor, an optical computer or a microprocessor. The computer program may be embodied as source code and undergo compilation for implementation on a computer, or may be embodied as object code, for example.

It is accordingly intended that all matter contained in the above description or shown in the accompanying drawings be interpreted as illustrative rather than in a limiting sense. It is also to be understood that the following claims are intended to cover all of the generic and specific features of the technology as described herein, and all statements of the scope of the technology which, as a matter of language, might be said to fall there between.

Having described the technology, what is claimed as new and secured by Letters Patent is:

1. A system for integrating a use and experience of a shared mobile app over a mobile device and a display device comprising:
a processor based device, at least one mobile application being stored on said processor based device;
a mobile device in selective communication with said processor based device;
a display device in selective communication with said processor based device;
said mobile device configured to remotely access and control at least a portion of said mobile application stored on said processor based device; and,
said processor based device configured to display said mobile application on said display device.

2. The system according to claim 1 wherein said processor based device is further configured to display said mobile application on said mobile device.

3. The system according to claim 2 wherein said processor based device configured to simultaneously display said mobile application on said display device and said mobile device.

4. The system according to claim 1 further comprising a plurality of display devices in selective communication with said processor based device.

5. The system according to claim 4 wherein said processor based device is configured to simultaneously display said mobile application on said plurality of display devices.

6. The system according to claim 1 wherein said processor based device includes software which is configured to mirror a video stream from said mobile application to said mobile device.

7. The system according to claim 1 wherein said co-device is configured to receive input signals from said mobile device and transform said input signals and display the transformed input signals on the display device.

8. The system according to claim 1 further comprising a companion application stored on said mobile device and configured to communicate with and control said mobile application stored on said processor based device.

9. A method of integrating the use and experience of a mobile application over a mobile device and a display device, the method comprising:
the mobile device selectively communicating with a co-device; wherein the co-device includes the mobile application stored on the co-device;
said mobile device remotely operating at least a portion of said mobile application;
said co-device displaying said remotely controlled mobile application on a display device, said display device being in selective communication with said co-device.

10. The method according to claim 9 further including said co-device transmitting a video stream from said mobile application for display on said mobile device.

11. The method according to claim 10 wherein said co-device simultaneously displays said remotely controlled mobile application on said mobile device and on said display device.

12. The method according to claim 10 further comprising said co-device simultaneously displaying said remotely controlled mobile application on said mobile device and on a plurality of display devices wherein each of said plurality of display devices is in selective communication with said co-device.

13. The method according to claim 9 further comprising said co-device authenticating said mobile device prior to said mobile device remotely controlling said mobile application.

14. The method according to claim 9 further comprising said mobile device providing a right brain interface for remotely operating said mobile application.

15. The method according to claim 11 wherein the mobile device includes a smart watch the method further comprising controlling the right brain interface using a turning wheel on a smart watch, wherein the smart watch includes virtual buttons on a display, to scroll through a plurality of selection dimensions of the right brain interface and select at least one of said dimensions.

16. The method according to claim 9 further comprising said co-device authenticating said display device.

17. The method according to claim 9 further including said co-device receiving input signals from said mobile device, transforming said input signals and displaying the transformed input signals on the display device.

18. An apparatus for integrating a use and experience of a mobile app between a mobile device and display device, the apparatus comprising:
a non-transitory machine-readable medium; and a plurality of instructions in the machine-readable medium which, when executed by a processing machine, enable the processing machine to perform operations comprising:
storing and running a mobile application;
selectively communicating with said mobile device and with said display device;
receiving access and control commands for said mobile application from said mobile device; and,
transmitting video associated with said mobile application for display on said display device.

19. The apparatus according to claim 18 further comprising, said processing machine performing an operation of receiving input signals from said mobile device, transforming said input signals and transmitting said transformed input signals for display on the display device.
